(19) United States
(12) Patent Application Publication
(10) Pub. No.: US 2012/0012727 A1
(43) Pub. Date: Jan. 19, 2012

(54) Tubular Telecom Tower Structure

(75) Inventor: Peter Häger, Djursholm (SE)

(73) Assignee: TELEFONAKTIEBOLAGET LM ERICSSON (PUBL), Stockholm (SE)

(21) Appl. No.: 13/257,321

(22) PCT Filed: Jun. 18, 2009
(86) PCT No.: PCT/SE2009/050769

§ 371 Date: Sep. 19, 2011

Related U.S. Application Data
(60) Provisional application No. 61/161,475, filed on Mar. 19, 2009.

(51) Int. Cl. H01Q 1/12; H01P 11/00

(52) U.S. Cl. 248/519; 29/600

(57) ABSTRACT

The present invention aims to provide a hollow antenna tower structure for use in a wireless communications net-work. The tower comprises tubular tower sections made of concrete, and having a generally hollowed cross section. The tower further comprises a connecting section 10 located between said conical shaped base section and tubular shaped upper section, the connecting section 10 is made of a metal or an alloy, such as steel.

### TECHNICAL FIELD

The present invention generally relates to telecom towers, and in particular, to a tubular antenna tower structure for use in a wireless communications system.

### BACKGROUND

Prevailing technology for telecom towers/masts, whether self supported or guyed, are lattice steel constructions. These masts are often galvanized using hot dip galvanization, where the steel structure is coated with a layer of Zinc. Steel towers are usually manufactured for a design life between 30-50 years. Coated structures are sensible to mechanical wear, and lattice steel towers are no exception. Towers get surface damages during transportation and installation, and such damages need to be mended when the tower is installed. Since hot dip is not an option when the tower is installed, painting/spraying with cold galvanization is a method used. Damages to a protective Zink layer can not be avoided during transportation and installation and corrosion will start at damaged areas. Corrosion is what sets design life for all steel structures, and regardless of Zink cotes, certain maintenance is required to stop corrosion during a construction life time.

WO-2008136717-A1 discloses an antenna tower elongated structure which comprises base, intermediate, and terminating segments (S1-S4). The segments are reinforced concrete, and interconnected in a longitudinal direction by elongated fastening members that together form a longitudinal interconnection structure that interconnect the base segment to the terminating segment without gaps in the longitudinal direction. Each segment comprises fastening member guides formed in the wall of the segment and arranged to preserve the fastening members at predetermined configuration with respect to the segment. See FIG. 1 and FIG. 2.

WO-2007108766-A1 and WO-2007108765-A1 disclose hollow conical antenna tower structures comprising vertical elongated tower body with an internal installation shaft. The tower is arranged to house a radio base station and the tower body comprises greater than or equal to 2 modular segments provided with mating interconnection mechanism comprising mating guide structures.

WO-2007108731-A1 discloses an antenna tower structure comprises Radio Base Stations; tubular tower sections having hollowed cross section; arrangement for moving a whole antenna radio base station along an elongation of the antenna tower structure, the antenna radio base station being disposed inside the tubular tower; and entrance into the antenna tower structure giving access for service of the antenna Radio Base station.

Other types of telecom towers/masts exist and are referred to as Monopoles, which basically are steel, aluminium or concrete poles on which a telecommunication system is attached on an external surface part.

In earlier versions of tower structures the second section between the ground section, conical section, and the third section, cylindrical section, is mostly made partially conical partially cylindrical. This was done in order to minimize and overcome some of the stress caused by horizontally forces combined with vertically forces. The second section was made according to FIG. 2b in one part or in two parts as in FIG. 2a. The stress on this section is very high due to its shape and due to the total shape of the tower. Also the strands inside the tower cause horizontal stress on the area between the conical shaped part and the cylindrical shape part since the post tension strands change direction from the lower parts to the upper parts of the earlier tower constructions. Large horizontal forces from the cables acting on the conical-circular cross area require large amounts of reinforcement in this specific part. This is even more important in location wherein earthquakes and other natural phenomenon might increase construction requirements. The shape and the forces on the section of prior art solutions imply that it has to be wet cast in a double sided mould. This resulted in a labour intensive and time consuming manufacturing process, and hence expensive. Manufacturing such a part in one form requires a quite complicated technique and resources not available in all part of the world. The special concrete ingredient used, in order to fulfil different requirements in different parts of the world, is not suitable for large scale production of a partially conical section as in FIG. 2b. Also a totally conical tower would require a lot of work since every section need to be conical and the force on the connecting parts between the sections would be quite high.

### SUMMARY

An embodiment of the present invention is therefore to introduce an antenna tower structure for use in a wireless communications network, wherein the tower is adapted for large scale production and less expensive to produce.

It is an object of the present invention to solve the problem of providing a more solid construction which also is easy to manufacture and which is possible to manufacture having regard to different manufacturing processes in different locations around the world.

This is achieved by the present invention which provides an antenna tower structure comprising a plurality of sections and wherein at least one connecting section, preferably second section, is made of a metal and/or an alloy such as steel, iron or any other similar material. The connecting section is located between a conical shaped base section and tubular shaped upper section, both with a hollowed cross section, of the tower. The antenna tower structure is arranged for use in a wireless communications network and for comprising one or more Radio Base Stations, RBSs.

An advantage achieved by introducing the connecting section is that most of the force between the conical and tubular parts of a heavy construction is captured by an easy to manufacture, solid and easy adjustable section.

In yet a further embodiment of the invention the connecting section is adapted to connect upper post tension strands and/or lower post tension strands.

An advantage achieved by this is that the whole tower has a connecting stabilising part that holds the construction together when the tower is exposed to tension forces, such as storms, hurricanes and earthquakes.

### BRIEF DESCRIPTION OF THE DRAWINGS

FIG. 1 illustrates an antenna tower structure according to the prior art.

FIGS. 2a and 2b illustrates each a tower structure section sketch according to prior art.

FIGS. 3a and 3b illustrate a tower structure connecting section according to an embodiment of the present invention.

FIG. 4 illustrates a tower structure connecting section comprising a lower lid injection holes and sealing parts according to an embodiment of the present invention.

FIG. 5 illustrates a tower structure connecting section comprising adjusting means according to a further embodiment of the present invention.

### DETAILED DESCRIPTION

Benefits of creating a tower, as described by the present invention, in concrete are uncountable. Problems with corrosion, cables and feeders out in the open, radio transmission interruption during service or reparation etc., are to be avoided by the present invention.

According to an embodiment of the present invention an antenna tower structure (ATS) is manufactured from reinforced concrete and wherein one connecting section is made of a metal or an alloy, such as steel. The metal or alloy connecting section makes it easier to mass produce such tower in a simpler and more cost effective manufacturing process. Preferably, the second section is made of a metal or an alloy such as steel. The second steel section is preferably conical shaped as the base section. This way the production procedure is simplified while still maintaining the benefits of the prior art towers mentioned above.

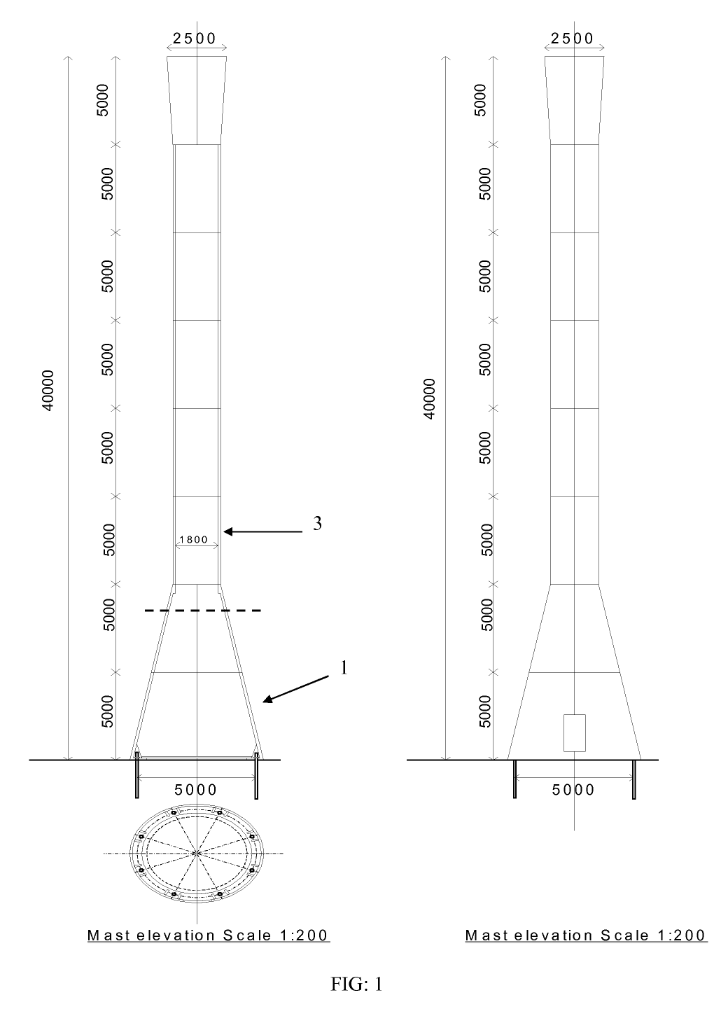

FIG. 1 illustrates a general form of an antenna tower structure according to prior art. This geometric form can still be used in combination with the present invention. This is considered to be a suitable form as a start of point since this tower has at least one tubular shaped upper section 2 with a hollow cross section and one conical shaped base section 1 with a hollow cross section. Preferably five such upper sections are used. The base section is made of segments (quarters, octets etc) that are connected together into forming the ground section. The tower structure, including all its sections, is a thin wall construction, leaving the entire tower structure to be hollow from its lowest part, base section, to its top. The segments and the sections are attached to each other by bolts or adhesive or a combination of both. Other techniques to attach the sections, such as but not limited to, welding, screwing, rivet together, locking mechanism, wedging are also to be used. The tower according to FIG. 1 illustrates a tower structure according to prior art wherein all parts, except the top section, are made of concrete.

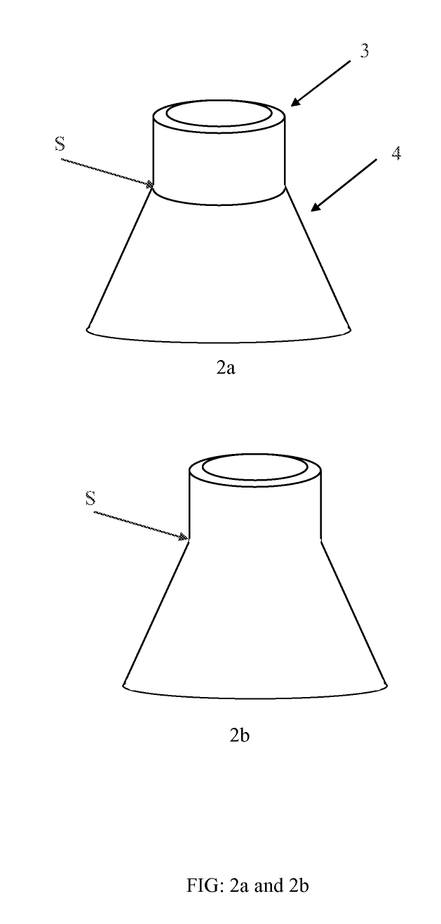

FIGS. 2a and 2b illustrate as mentioned above two alternatives of a connecting tower section, usually a second section, which is a connecting section between a tubular upper section of the tower and a more conical base section. The tubular upper section is typically cylindrical but can also be slightly conical as well as any other similar form. In FIG. 2a the connecting section is made of two parts, a conical part 4 and a tubular part 3 (less conical or cylindrical). As mentioned above the stress on this section, especially on the overlapping point S, requires that the connecting section includes heavily reinforcement. Also manufacturing process of such a part in one piece puts a challenging task on the manufacturing process. This is not a large scale friendly manufacturing process. Manufacturing the connecting section in two parts as in FIG. 2a resulted in more problems because of the brittle/frail nature of concrete. Large stress force on the overlapping point S caused breaks and cracks in the concrete section.

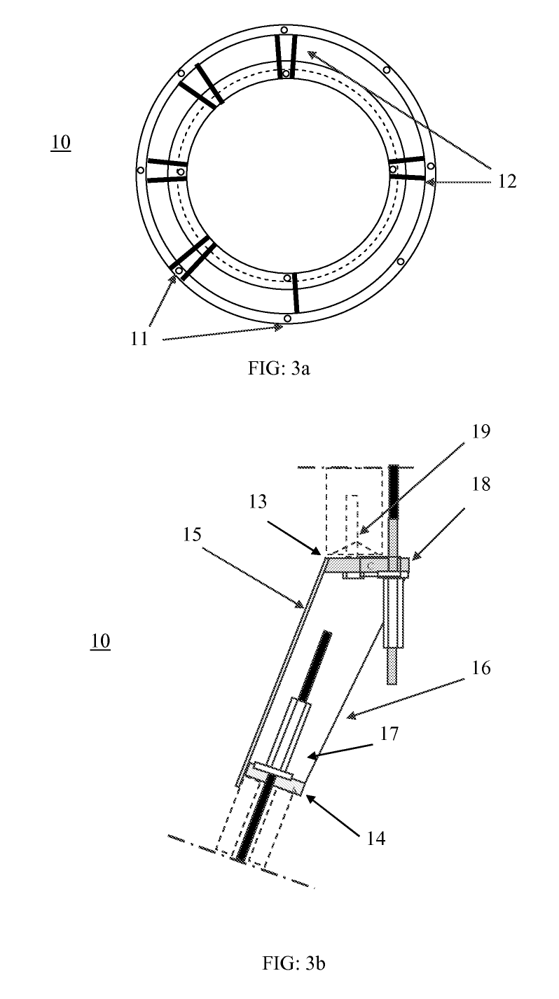

FIG. 3a illustrates a tower structure connecting section with a hollow cross section according to an embodiment of the present invention. The figure is an overview of a tubular section 10 looking at the section along the elongation of the tower (down-up overview). The section 10 comprises a number of holes 11 adapted for post tension strands attachment or for attachment to other sections. The section 10 further comprises stiffener beams 12 between an upper lid part and a lower lid part. Typically the section comprises one beam on each side of each strand hole. Preferably 16 beams are used. The beams are used to support the section and further on the whole tower structure. According to this embodiment the connecting section 10, which is typically located between the conical shaped base section and the tubular shaped upper section, is made of a metal or an alloy, such as steel. The figure illustrates a conical shaped connecting section but the invention is not limited to this form.

An advantage of making the section in the tower in for example steel give the benefit that post tension strands may be directly attached to attachment parts 11 in the section 10. Also the connecting part is made of a solid material which does not deform or crack as easy as concrete when exposed to both horizontal and vertical stress forces.

FIG. 3b illustrates a further cross section view of the tower structure connecting section 10 according to an embodiment of the present invention. The section comprises a top lid part 13, a lower lid part 14, an outer surface 15 and inner surface 16. The section 10 further comprises lower lid strands attachment arrangements 17 and top lid strands attachment arrangements 18. The lower lid strands attachment arrangements 17 are used for attaching strands from a base section or from a foundation part of the tower structure. The connecting section 10 further comprises additional section attachment holes 19 for attaching the section 10 to the upper section and/or to the base section. In the figure, as an example a bolt is shown for attaching to the upper section, in dashed lines. The beams are not shown in this figure.

According to this embodiment of the present invention the strands are connected in a two-step-procedure which is totally new compared to prior art. According to a preferred embodiment of the present invention the post tension strands (wires) all connect in the mentioned section 10. A number of cables connect from the foundation or the ground section to the lower part of the connecting section and a plurality of cables connect from the upper part of the “second” connecting section 10 to the tower part of a top section. In the figures holes for 8 cables shown even though possible to use any other number. Hence, the entire tower of the present invention is under compression from its lowest part to the top section by aid of a solid section.

The effect of such a construction is that the section forms and acts as a stabilization part in the tower. This is different from prior art versions which did not have this possibility. An additional benefit of the present invention is that the amount of reinforcement needed to achieve a solid construction is reduced.

In a further embodiment of the invention the outer and the inner surfaces 15 and 16 of FIG. 3b are made of a protective surface with partially transparent areas, such as plastic. The surfaces thereby forms a 360 degree, circularly surrounding, window which will lead daylight into the inside hollow part of the tower. Alternatively the surfaces are made of a protecting metal layer. The surface may also include air flow ventilation holes.

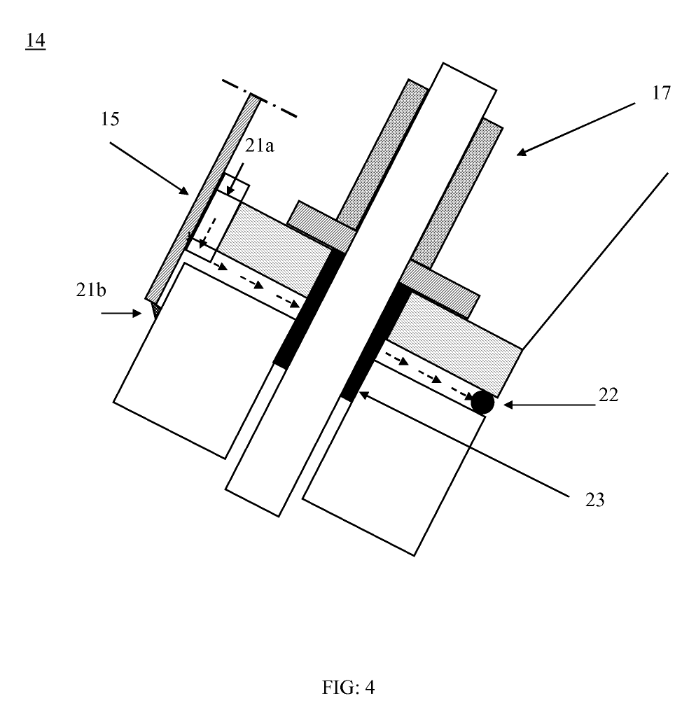

FIG. 4 illustrates a tower structure connecting section 10 comprising lid injection holes or sealing parts 21a, 21b and according to an embodiment of the present invention. According to this embodiment one or more injection holes 21a, 21b, and 22 and one or more sealing parts 21a, 21b and 22 are adapted to be used for filling up and sealing gaps or cracks in the concrete or between the connecting section and the upper or base section. Any of 21a, 21b or 22 is a hole or a sealing part. The lower lid strands attachment arrangements 17 may further include strands sealing parts 23 adapted to seal the strands from injected concrete. In a further embodiment the injection parts are soft joints, easily removable sealing parts, leading to gaps between stress surfaces, shown with dashed arrows in the figure. The injection parts may also be used for filling up gaps between segments of the base section. Additionally one or more of the injection parts 21a, 21b or 22 are used as a sealing part. The connecting section 10 comprises several lid injection holes or sealing parts 21a, 21b and 22 in the lower lid part 14.

In a further embodiment both the lower and the upper lid part 13 includes such injection holes and/or sealing parts. The invention is by now way restricted to holes and sealing parts in only in the lower lid part 14.

In an additional embodiment the connecting section includes a lower lid part 14 with holes in it allowing injection of concrete in the vertical joints of elements of a base section. Such injection would not have been possible with concrete against concrete as in prior art solutions.

Again the solution according to FIG. 4 was not possible in prior art solutions which had problems with cracking surfaces in joint parts between the base section and the connecting section. The effect of this implementation is that stress in this heavy loaded area is reduced by an even load distribution resulting in fewer cracks in the concrete. The dimensions mentioned in the figures are not by any way limiting but other dimensions are possible.

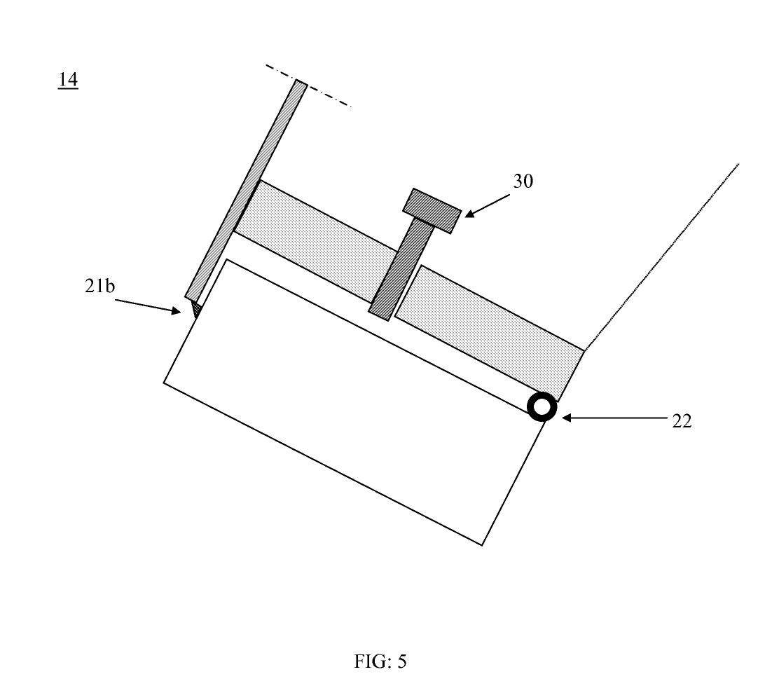

FIG. 5 illustrates a tower structure connecting section comprising adjusting means 30 according to a further embodiment of the present invention. According to this embodiment the lower lid part 14 of the connecting section 10 further comprises one or more adjusting means 30 adapted to be used for stabilising the connecting section 10. Typically, the one or more adjusting means 30 are a screw mechanism wherein the connecting section is stabilised by the one or more screws. In a further embodiment the screw mechanism 30 is combined with the injection procedure of FIG. 4, in order to fill up the gaps after that the connecting section is stabilised and in place. Similar adjusting means may be included in the upper lid part 13. Typically, but not in any way restricting, three screws are used to stabilise the section.

Different procedures for attaching the strands to the connecting section are possible, other than those showed in FIGS. 3b and 4. Alternatively, the strands are attached from the inner side along the inner wall of the tower e.g. not inside the sections. The effect of this implementation is to achieve a homogenous solid tower with less vertical holes in sections.

While the invention has been described with reference to specific exemplary embodiments, the description is in general only intended to illustrate the inventive concept and should not be taken as limiting the scope of the invention.

It will be understood by those skilled in the art that various modifications and changes may be made to the present invention without departure from the scope thereof, which is defined by the appended claims.

1-11. (canceled)

12. An antenna tower structure for one or more Radio Base Stations for use in a wireless communications network, the antenna tower structure comprising:
at least one conical shaped base section with a hollow cross section;
at least one tubular shaped upper section with a hollow cross section; and
a connecting section with a hollow cross section located between said conical shaped base section and said tubular shaped upper section, the connecting section comprised of a metal or an alloy.

13. The antenna tower structure according to claim 12, wherein the connecting section is comprised of steel.

14. The antenna tower structure according to claim 12, wherein the at least one conical shaped base section and the at least one tubular shaped upper section are comprised of concrete.

15. The antenna tower structure according to claim 14, wherein the connecting section has a conical shape.

16. The antenna tower structure according to claim 14, wherein the connecting section comprises the second section of the tower structure.

17. The antenna tower structure according to claim 16, wherein the connecting section is arranged to connect post tension strands running along an inner wall surface of the tower structure.

18. The antenna tower structure according to claim 16, wherein the connecting section is configured to connect post tension strands running inside the at least one conical shaped base section and the at least one tubular shaped upper section and along the elongation of the tower structure.

19. The antenna tower structure according to claim 12, wherein the connecting section is further configured to function as at least one of a connecting section for upper section post tension strands and a connecting part for base section post tension strands.

20. The antenna tower structure according to claim 19, wherein the connecting section comprises an upper lid part, a lower lid part, and stiffener beams arranged between the upper lid part and the lower lid part.

21. The antenna tower structure according to claim 12, wherein the connecting section further includes an outer surface adapted for sealing the section.

22. The antenna tower structure according to claim 21, wherein the outer surface includes areas comprised of a transparent material for letting sunlight into the inside of the tower structure.

23. The antenna tower structure according to claim 12, wherein the connecting section further includes injection holes and sealing parts adapted to allow injection and sealing of concrete into areas between the connecting section and the other sections.

24. The antenna tower structure according to claim 12, wherein the connecting section further includes one or more adjusting elements adapted to stabilize the connecting section.

25. The antenna tower structure according to claim 24, wherein at least one of the adjusting elements comprises a screw mechanism comprising one or more screws.

26. A method of assembling an antenna tower structure for one or more Radio Base Stations for use in a wireless communications network, the antenna tower structure comprising at least one conical shaped base section with a hollow cross section, at least one tubular shaped upper section with a hollow cross section, and a connecting section located between the conical shaped base section and the tubular shaped upper section, the method comprising:
connecting a number of cables from the conical shaped base section to a lower part of the connecting section, said connecting section having a hollow cross section and comprised of a metal or an alloy; and
connecting a plurality of cables from an upper part of the connecting section to the tubular shaped upper section.

27. The method according to claim 26, wherein the connecting section further includes injection holes, and wherein the method further comprises: injecting concrete into areas between the connecting section and the other sections via the injection holes.

28. An antenna tower structure for use in a wireless communication network and comprising:
at least one concrete conical base section;
at least one concrete upper section having a generally hollow construction; and
a metal connecting section also having a generally hollow construction and configured to evenly distribute the load between the concrete conical base section and said concrete upper section;
wherein said metal connecting section includes lower attachment points configured to interconnect said metal connecting section to one or more of said at least one concrete conical base sections via one or more lower tension strands running inside said antenna tower structure, and upper attachment points configured to interconnect said metal connecting section to one or more of said at least one upper concrete sections via one or more upper tension strands running inside of said metal connecting section.
